(19) United States
(12) Patent Application Publication
(10) Pub. No.: US 2003/0117260 A1
(43) Pub. Date: Jun. 26, 2003

(54) Access control system

(75) Inventor: David G.J. Fanshawe, Croydon (GB)

Correspondence Address: PHILIPS ELECTRONICS NORTH AMERICAN CORP, 580 WHITE PLAINS RD, TARRYTOWN, NY, 10591, US

(73) Assignee: KONINKLIJKE PHILIPS ELECTRONICS N.V.

(21) Appl. No.: 10/323,416

(22) Filed: Dec. 19, 2002

(30) Foreign Application Priority Data
Dec. 22, 2001 (GB) 0130810.5

(51) Int. Cl. H04Q 1/00

(52) U.S. Cl. 340/5.7

(57) ABSTRACT

An access control system includes a tag carried by a user which communicates over a short range wireless link to door lock controller to provide to the controller a security access code and actuate door release means. In the event the correct access code is not known by the tag, the tag communicates with access code repository and requests a valid access code. When requesting the valid access code, the tag also communicates to the repository an identity provided by the door release means and an identity of the tag itself. A decision may then be taken whether to provide the tag with a valid access code for that particular door release means. The door release means may provide the tag with a telephone number to call when making the request to the repository.

The present invention relates to an access control method and apparatus for carrying out the method.

Known access control systems include conventional mechanical door locks requiring a physical key or locks requiring a user to input an access code, such as a number combination into a keypad. Another known type of access control system is commonplace in vehicle locking systems where a users handheld radio transmitter communicates with locking equipment fitted to the vehicle. Such an arrangement is described in U.S. Pat. No. 5,134,392. The above arrangements do however, cause some inconvenience for authorised personnel, who must remember to carry the right key or transmitter device or remember an access code in order to gain entry. One further disadvantage of the above mentioned systems is it is difficult to restrict authorised access of those in possession of the key, transmitter or code to particular times.

It is an object of the present invention to provide a method and apparatus that seeks to address the above mentioned problems.

In accordance with a first aspect of the present invention there is provided a method of operating an access control system having:

locking device control means for coupling to a locking arrangement, said control means generating an enabling signal to initiate actuation of said locking arrangement on reception of a valid access code; and

locking device command means for providing an access code to such a locking device control means, said method comprising the steps of:

determining whether a provided access code received at the locking device control means is valid and generating said enabling signal in the case that the received code is valid; otherwise in the case the received code is not valid the method further comprises the steps of:

causing the locking device command means to request a valid access code from a code repository and, in the event such a code is made available;

relaying that valid code from the locking device command means to the locking device control means.

Such a locking device command means may be a self contained device or incorporated or connectable with other devices. In particular the locking device command means may be accommodated in mobile telecommunications apparatus, such that whenever a person is carrying the mobile telecommunications apparatus they have the potential to operate an access control system without a separate key. When a person approaches an access, such as a door, that is fitted with a locking arrangement coupled to locking device control means, the door may unlock automatically for a person carrying locking device command means holding a valid access code.

If the command means does not have a code that is valid for a particular locking device control means, the command means may accesses a code registry to request a valid code. Whether or not a valid code is provided can depend on the locking device control means identity in question, which in general will correspond to a particular door fitted with a locking arrangement. Furthermore, whether or not a valid code is provided may also depend on the identity of the command means in question, which may potentially indicate a user or group of users of the apparatus fitted with the locking device command means.

The validity of any access codes may be time dependent in order to restrict the times that a particular device fitted with command means may initiate operation of a locking arrangement. This may be done to restrict the times particular individuals may obtain access, for example during weekday working hours only. This may also be done to enable access for a finite time as may be required, for example, when providing a visitor with access for a particular day only.

The locking device control means may provide the locking device command means with repository access information, for example the correct telephone number to call to access the repository.

Communication between said locking device control means and said locking device command means can be encrypted using appropriate means, such as public key encryption technology, in order to prevent unauthorised capturing of access codes. Encryption may also be employed for communications established between the locking device command means and the repository.

These and other aspects and optional features of the present invention appear in the appended claims to which the reader is now referred and which are incorporated herein by reference.

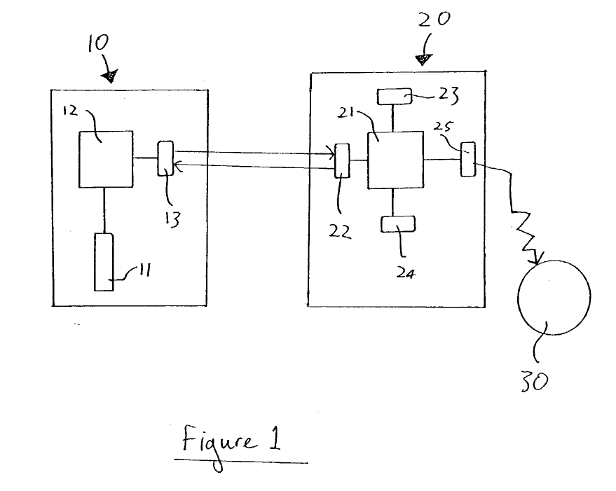

The present invention will now be described with reference to the FIGURE of the accompanying drawings wherein FIG. 1 shows in schematic form the functional features of apparatus employing the present invention.

An electronic door lock 10 includes a locking arrangement having lock actuation means 11 and locking device control means 12 for providing an enabling signal to the lock actuation means. Locking device control means 12 is provided with a radio frequency (RF) transceiver 13. A locking device command means 20 is provided in a mobile telephone and comprises processor 21, first RF transceiver 22 for communicating with locking device control means 12 via transceiver 13, first memory storage means 23 for holding command means identification data, second memory storage means 24 for holding access codes for particular various locking device control means 12, and second transceiver means 25 for communicating with a remote database 30 that serves as a repository from which valid access codes may be requested.

Either or both of the first memory storage means 23 and second memory storage means 24 may be provided as removable components, such as removable cards, allowing such cards, containing command means identification data and/or access codes, to be swapped between equipment that is enabled with the locking device command means facility or apparatus 20. Indeed, the whole locking device command means 20 may be provided as a removable tag.

In use, a person carrying a mobile telephone handset equipped with the locking device command means 20 (hereinafter referred to as telephone equipped with tag 20) approaches an electronic door lock 10. The lock controller 12 transmits its identification code using transceiver 13 over a short range wireless communication link established with transceiver 22 of tag 20. Tag 20 processes the received identification code to determine whether the tag 20 contains in memory 24 an access code valid for returning to lock controller 12 to enable actuation of actuation means 11. If so, a valid access code is communicated from tag 20 using transceiver 22 to the transceiver 13 of lock controller 12, which causes enablement of actuation means 11 thus operating the locking mechanism of a door or the like. In this example the particular lock controller 12 may be one that appears on an ‘immediate access’ list held in the tag 20, together with the appropriate access code for that lock controller 12, thus immediate access is granted.

If, on the other hand tag 20 processes the received identification code of controller 12 and determines that memory 24 does not contain a valid access code to return to lock controller 12, the processor 21 of tag 20 activates second transceiver 25 to communicate with remote repository 30 provided in the form of a security centre or the like and requests a valid access code. In the case were the tag is part of a communications apparatus, transceiver 25 may be a component of the communications apparatus. In making the request, the tag 20 also provides its own identification held in memory 23 and a check is performed at the security centre, either automatically or manually, to determine if a tag originating such a request should be provided with a valid access code. Furthermore, the tag 20 also communicates to the security centre the identity of the lock controller 12 so it is possible to determine whether a particular tag 20 should receive a valid code and also whether a code should be provided for a particular lock. Such access codes typically have a short lifetime so that if a user returns to a the locking controller 12 at a later time with tag 20, the code will no longer be valid.

The locking controller 12 may provide to the tag 20 the information required to request an authorisation code. Such information includes, for example, a telephone number to dial to contact to the access code repository 30.

Thus, the system offers convenience for regular users and better security than a conventional key against loss or theft. It is also suitable for occasional users, for example service and delivery personnel, where access can be restricted to certain times or a particular visit. The system also provides traceability of tags 20 using the system. All casual users can be logged and any attempt to breach security recorded.

Typically any negotiation performed between the lock controller 12 and tag 20 will be over a short range wireless link, typically in the order of a few millimetres to a few metres, depending on the radio communication system adopted and preferences in terms of usability and security considerations. While the link has been described as a radio link between transceivers 13 and 22, other wireless links could be employed between the locking device control means 12 and locking device command means 20, such as optical infrared links or ultrasonic links.

The locking device command means 20 may be provided in equipment other than a mobile telephone, such as in a personal digital assistant, security radio equipment, data recording equipment or wearable computing apparatus, as will be apparent to the person skilled in the art.

While the present invention has been described primarily with reference to a physical security system installed to restrict entry of persons to premises, this is by way of example only and should not be interpreted as an undue limitation to the scope of the present invention. It should be noted that the present invention may also be employed in arrangements such as a computer terminal or other control consoles for operation of machinery or apparatus. In this case the terminal or console would be fitted with locking device control means 12 but the lock activation means 11 may actuate a physical lock or some other access control arrangement, such as an electronic machine enabling/disabling function. Thus, operation of the terminal or console will not be possible without a user being in possession of locking device command means 20 which may be in the form of a tag 20 containing a valid access code.

From reading the present disclosure, other modifications will be apparent to persons skilled in the art. Such modifications may involve other features which are already known in the design, manufacture and use of security access systems, communication, encryption, access coding and code repository arrangements and applications thereof and which may be used instead of or in addition to features already described herein.

1. A method of operating an access control system having:
locking device control means for coupling to a locking arrangement, said control means generating an enabling signal to initiate actuation of said locking arrangement on reception of a valid access code; and
locking device command means for providing an access code to such a locking device control means, said method comprising the steps of:
determining whether a provided access code received at the locking device control means is valid and generating said enabling signal in the case that the received code is valid; otherwise in the case the received code is not valid the method further comprises the steps of:
causing the locking device command means to request a valid access code from a code repository and, in the event such a code is made available;
relaying that valid code from the locking device command means to the locking device control means.

2. A method according to claim 1 wherein said locking device command means has identification data and said step of causing the command means to request a valid access code includes forwarding to said repository the command means identification data, wherein the making available of a valid access code from the code repository to the command means is conditional on the particular command means identification data received.

3. A method according to claim 1 wherein said locking device control means has identification data and said step of causing the command means to request a valid access code includes forwarding to said repository the control means identification data furnished to the command means by the control means, wherein the making available of a valid access code from the code repository to the command means is conditional on the particular control means identification data received.

4. A method according to claim 1 wherein said locking device command means has identification data and said locking device control means has identification data and said step of causing the command means to request a valid access code includes forwarding to said repository the command means identification data and the control means identification data furnished to the command means by the control means, wherein the making available of a valid access code from the code repository to the command means is conditional on the particular command means identification data received and the particular control means identification data received.

5. A method according to claim 1, wherein the validity of said access codes is time dependent.

6. A method according to claim 1 and further comprising the step of:
providing the locking device command means with repository access information that is derived from the locking device control means.

7. A method according to claim 1 wherein communication between said locking device control means and said locking device command means is encrypted.

8. Apparatus having the technical features of the locking device control means of claim 1.

9. Apparatus having the technical features of the locking device command means of claim 1.

10. An information storage system configured to function as the code repository of claim 1.

11. A system configured to carry out the method of claim 1.

12. A locking device command means configured for providing an access code to a locking device control means of the type for coupling to a locking arrangement, the control means arranged to generate an enabling signal to initiate actuation of said locking arrangement on reception of a valid access code from the command means, said locking device command means comprising means for requesting a valid access code from a code repository for a given control means in the event it is determined that the command means does not already posses a valid access code for that locking device control means.

13. A locking device control means for coupling to a locking arrangement, said control means generating an enabling signal to initiate actuation of said locking arrangement on reception of a valid access code transmitted from a locking device command means, wherein said locking device control means comprises communication means for indicating to a command means control means identification data.
